(19) United States
(12) Patent Application Publication
(10) Pub. No.: US 2010/0140835 A1
(43) Pub. Date: Jun. 10, 2010

(54) Styrenic polymers for injection stretch blow molding and methods of making and using same

(75) Inventors: Luyi Sun, Houston, TX (US); Ted Harris, Houston, TX (US); Juan Aguirre, League City, TX (US); Mark Leland, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/330,915

(22) Filed: Dec. 9, 2008

(51) Int. Cl. B29C 71/02; C08L 67/02

(52) U.S. Cl. 264/234; 524/513

(57) ABSTRACT

A method comprising preparing a styrenic polymer composition, melting the styrenic polymer composition to form a molten polymer, injecting the molten polymer into a mold cavity to form a preform, heating the preform to produce a heated preform, and expanding the heated preform to form an article. A method comprising substituting a styrenic polymer composition comprising from 0 wt. % to 6.5 wt. % plasticizer and equal to or greater than 2.5 wt. % elastomer for polyethylene terephthalate in an injection stretch blow molding process, wherein the wt. % is based on the total weight of the polymeric composition. A method comprising preparing a preform from a styrenic polymer composition, subjecting the preform to one or more heating elements, and rapidly heating the preform to produce a heated preform.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

This disclosure relates to methods of preparing a styrenic polymer. More specifically, this disclosure relates to a styrenic polymer for injection stretch blow molding (ISBM) and methods of making and using same.

2. Background

Synthetic polymeric materials are widely used in the manufacturing of a variety of end-use articles ranging from medical devices to food containers. Copolymers of monovinylidene aromatic compounds such as styrene, alpha-methylstyrene and ring-substituted styrene comprise some of the most widely used thermoplastic elastomers. For example, styrenic copolymers can be useful for a range of end-use applications including disposable medical products, food packaging, tubing, and point-of-purchase displays.

Blow molding is a primary method for forming hollow plastic objects such as soda bottles. The process includes loading a softened polymer tube which can be either extruded or injected, reheating the softened polymer tube into a mold, inflating the polymer against the mold walls with a blow pin, and then cooling the product in the mold. Within the packaging industry, there are a number of unique applications such as ISBM that utilize polyesters such as polyethylene terephthalate (PET). Manufacturers continue to explore alternative polymers and methods of preparing same for ISBM applications that could reduce manufacturing costs, increase energy savings and/or improve product properties. Given the foregoing discussion, it would be desirable to develop alternative polymeric compositions for ISBM applications with desirable mechanical and/or physical properties while having reduced manufacturing costs.

### SUMMARY

Disclosed herein is a method comprising preparing a styrenic polymer composition, melting the styrenic polymer composition to form a molten polymer, injecting the molten polymer into a preform mold cavity to form a preform, recovering the perform from the preform mold cavity, placing the perform into an article mold cavity, heating the preform to produce a heated preform, expanding the heated preform to form an article, and recovering the article form the article mold cavity.

Further disclosed herein is a method comprising substituting a styrenic polymer composition comprising from 0 wt. % to 6.5 wt. % plasticizer and equal to or greater than 2.5 wt. % elastomer for polyethylene terephthalate in an injection stretch blow molding process, wherein the wt. % is based on the total weight of the polymeric composition.

Also disclosed herein is a method comprising preparing a preform from a styrenic polymer composition, subjecting the preform to one or more heating elements, and rapidly heating the preform to produce a heated preform.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a drawing of preforms A and B.

FIG. 2 is a plot of maximum top load strength for the samples from Example 3.

FIG. 3 is a plot of bumper compression strength at half inch deflection for the samples from Example 4.

FIG. 4 is a plot of gloss 60° for the samples from Example 4.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are methods of preparing ISBM articles comprising preparing a styrenic polymer composition (SPC) and converting the SPC into an end-use article by ISBM. In an embodiment, the SPC comprises a high impact polystyrene (HIPS); alternatively a general purpose polystyrene (GPPS); alternatively a blend of a HIPS and a GPPS. In an embodiment, the compositions and methods disclosed herein may reduce manufacturing costs while maintaining desirable mechanical and/or physical properties of the resulting article.

In an embodiment, the SPC comprises polystyrene formed by the polymerization of styrene monomer and optionally one or more comonomers. Styrene, also known as vinyl benzene, cinnamene, ethyenylbenzene, and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene, disubstituted styrenes such as p-t-butyl styrene as well as unsubstituted styrenes. In an embodiment, the polystyrene is present in the SPC in an amount of from 1.0 weight percent (wt. %) to 99.9 wt. % by total weight of the SPC, alternatively from 5 wt. % to 99 wt. %, alternatively from 10 wt. % to 95 wt. %.

In an embodiment, a polystyrene suitable for use in this disclosure may have a melt flow rate of from 1 g/10 min. to 40 g/10 min., alternatively from 1.5 g/10 min. to 20 g/10 min., alternatively from 2 g/10 min. to 15 g/10 min. as determined in accordance with ASTM D-1238; a falling dart impact of from 5 in-lb to 200 in-lb, alternatively from 50 in-lb to 180 in-lb, alternatively from 100 in-lb to 150 in-lb as determined in accordance with ASTM D-3029; an Izod impact of from 0.4 ft-lbs/in to 5 ft-lbs/in, alternatively from 1 ft-lbs/in to 4 ft-lbs/in, alternatively from 2 ft-lbs/in to 3.5 ft-lbs/in as determined in accordance with ASTM D-256; a tensile strength of from 2,000 psi to 10,000 psi, alternatively from 2,800 psi to 8,000 psi, alternatively from 3,000 psi to 5,000 psi as determined in accordance with ASTM D-638; a tensile modulus of from 100,000 psi to 500,000 psi, alternatively from 200,000 psi to 450,000 psi, alternatively from 250,000 psi to 380,000 psi as determined in accordance with ASTM D-638; an elongation of from 0.5% to 90%, alternatively from 5% to 70%, alternatively from 35% to 60% as determined in accordance with ASTM D-638; a flexural strength of from 3,000 psi to 15,000 psi, alternatively from 4,000 psi to 10,000 psi, alternatively from 6,000 psi to 9,000 psi as determined in accordance with ASTM D-790; a flexural modulus of from 200,000 psi to 500,000 psi, alternatively from 230,000 psi to 400,000 psi, alternatively from 250,000 psi to 350,000 psi as determined in accordance with ASTM D-790; an annealed heat distortion of from 180° F. to 215° F., alternatively from 185° F. to 210° F., alternatively from 190° F. to 205° F. as determined in accordance with ASTM D-648; and a Vicat softening of from 190° F. to 225° F., alternatively from 195° F. to 220° F., alternatively from 200° F. to 215° F. as determined in accordance with ASTM D-1525.

In an embodiment, the SPC may be a styrenic homopolymer, which is also referred to as a GPPS or a crystal grade polystyrene. In an embodiment, a GPPS suitable for use in this disclosure may have a melt flow rate of from 1 g/10 min. to 40 g/10 min., alternatively from 1.5 g/10 min. to 20 g/10 min., alternatively from 1.6 g/10 min. to 14 g/10 min. as determined in accordance with ASTM D-1238; a tensile strength of from 5,000 psi to 8,500 psi, alternatively from 6,000 psi to 8,000 psi, alternatively from 6,200 psi to 7,700 psi as determined in accordance with ASTM D-638; a tensile modulus of from 400,000 psi to 500,000 psi, alternatively from 420,000 psi to 450,000 psi, as determined in accordance with ASTM D-638; an elongation of from 0% to 0.5% as determined in accordance with ASTM D-638; a flexural strength of from 10,000 psi to 15,000 psi, alternatively from 11,000 psi to 14,500 psi, alternatively from 11,500 psi to 14,200 psi as determined in accordance with ASTM D-790; a flexural modulus of from 400,000 psi to 500,000 psi, alternatively from 430,000 psi to 480,000 psi, as determined in accordance with ASTM D-790; an annealed heat distortion of from 185° F. to 220° F., alternatively from 190° F. to 215° F., alternatively from 195° F. to 212° F. as determined in accordance with ASTM D-648; and a Vicat softening of from 195° F. to 230° F., alternatively from 200° F. to 228° F., alternatively from 205° F. to 225° F. as determined in accordance with ASTM D-1525.

Examples of GPPS suitable for use in this disclosure include without limitation CX5229, 525, 500B, and 585, all of which are commercially available from Total Petrochemical USA, Inc. In an embodiment, the GPPSs (e.g., CX5229, 525, 500B, and 585) have generally the physical properties set forth in Tables 1-4.

TABLE 1

| | | |
|---|---|---|
| CX5229/GPPS | ASTM Test | Typical Value |

MELT FLOW

| | | |
|---|---|---|
| Flow, g/10 min., 200/5.0 | D-1238 | 3.0 |

IMPACT PROPERTIES

| | | |
|---|---|---|
| Falling Dart, in-lb | D-3029 | n/a |
| Izod, ft-lbs/in, notched | D-256 | n/a |

TENSILE PROPERTIES

| | | |
|---|---|---|
| Strength, psi | D-638 | 7,300 |
| Modulus, psi (10⁵) | D-638 | 4.3 |
| Elongation, % | D-638 | n/a |

FLEXURAL PROPERTIES

| | | |
|---|---|---|
| Strength, psi | D-790 | 14,000 |
| Modulus, psi (10⁵) | D-790 | 4.7 |

THERMAL PROPERTIES

| | | |
|---|---|---|
| Heat Distortion, ° F. Annealed | D-648 | |
| Vicat Softening, ° F. | D-1525 | 223 |

TABLE 2

| | | |
|---|---|---|
| 525 | ASTM Test | Typical Value |

MELT FLOW

| | | |
|---|---|---|
| Flow, g/10 min., 200/5.0 | D-1238 | 9.0 |

IMPACT PROPERTIES

| | | |
|---|---|---|
| Falling Dart, in-lb | D-3029 | n/a |
| Izod, ft-lbs/in, notched | D-256 | n/a |

TENSILE PROPERTIES

| | | |
|---|---|---|
| Strength, psi | D-638 | 6,700 |
| Modulus, psi (10⁵) | D-638 | 4.4 |
| Elongation, % | D-638 | n/a |

FLEXURAL PROPERTIES

| | | |
|---|---|---|
| Strength, psi | D-790 | 13,500 |
| Modulus, psi (10⁵) | D-790 | 4.5 |

THERMAL PROPERTIES

| | | |
|---|---|---|
| Heat Distortion, ° F. Annealed | D-648 | 200 |
| Vicat Softening, ° F. | D-1525 | 213 |

TABLE 3

| | | |
|---|---|---|
| 500B | ASTM Test | Typical Value |

MELT FLOW

| | | |
|---|---|---|
| Flow, g/10 min., 200/5.0 | D-1238 | 14 |

IMPACT PROPERTIES

| | | |
|---|---|---|
| Falling Dart, in-lb | D-3029 | n/a |
| Izod, ft-lbs/in, notched | D-256 | n/a |

TENSILE PROPERTIES

| | | |
|---|---|---|
| Strength, psi | D-638 | 6,100 |
| Modulus, psi (10⁵) | D-638 | 4.2 |
| Elongation, % | D-638 | n/a |

FLEXURAL PROPERTIES

| | | |
|---|---|---|
| Strength, psi | D-790 | 11,000 |
| Modulus, psi (10⁵) | D-790 | 4.4 |

THERMAL PROPERTIES

| | | |
|---|---|---|
| Heat Distortion, ° F. Annealed | D-648 | 189 |
| Vicat Softening, ° F. | D-1525 | 200 |

TABLE 4

| | | |
|---|---|---|
| 585 | ASTM Test | Typical Value |

MELT FLOW

| | | |
|---|---|---|
| Flow, g/10 min., 200/5.0 | D-1238 | 1.6 |

IMPACT PROPERTIES

| | | |
|---|---|---|
| Falling Dart, in-lb | D-3029 | n/a |
| Izod, ft-lbs/in, notched | D-256 | n/a |

TENSILE PROPERTIES

| | | |
|---|---|---|
| Strength, psi | D-638 | 7,600 |
| Modulus, psi (10⁵) | D-638 | 4.3 |
| Elongation, % | D-638 | n/a |

FLEXURAL PROPERTIES

| | | |
|---|---|---|
| Strength, psi | D-790 | 14,200 |
| Modulus, psi (10⁵) | D-790 | 4.3 |

THERMAL PROPERTIES

| | | |
|---|---|---|
| Heat Distortion, ° F. Annealed | D-648 | 211 |
| Vicat Softening, ° F. | D-1525 | 225 |

In some embodiments, the SPC may be an impact polystyrene or a high impact polystyrene (HIPS) that further comprises an elastomeric material. Such HIPS may contain an elastomeric phase that is embedded in the polystyrene matrix resulting in the composition having an increased impact resistance.

In an embodiment, the SPC is a HIPS comprising a conjugated diene monomer as the elastomer. Examples of suitable conjugated diene monomers include without limitation 1,3-butadiene, 2-methyl-1,3-butadiene, 2-chloro-1,3 butadiene, 2-methyl-1,3-butadiene, and 2-chloro-1,3-butadiene. Alternatively, the HIPS comprises an aliphatic conjugated diene monomer as the elastomer. Without limitation, examples of suitable aliphatic conjugated diene monomers include C₄ to C₉ dienes such as butadiene monomers. Blends or copolymers of the diene monomers may also be used. Likewise, mixtures or blends of one or more elastomers may be used. In an embodiment, the elastomer comprises a homopolymer of a diene monomer, alternatively, the elastomer comprises polybutadiene. The elastomer may be present in the HIPS in amounts effective to produce one or more user-desired properties. Such effective amounts may be determined by one of ordinary skill in the art with the aid of this disclosure. In an embodiment, the elastomer may be present in the HIPS in an amount of equal to or greater than 1 wt. %, alternatively from 6 wt. % to 10 wt. %, alternatively 6, 7, 8, 9, or 10 wt. %, alternatively from 8 wt. % to 9 wt. %, alternatively from 8.3 wt. % to 8.7 wt. %, alternatively 8.5 wt. %.

In an embodiment, a HIPS suitable for use in this disclosure may have a melt flow rate of from 1 g/10 min. to 40 g/10 min., altern atively from 1.5 g/10 min. to 20 g/10 min., alternatively from 2 g/10 min. to 15 g/10 min. as determined in accordance with ASTM D-1238; a falling dart impact of from 5 in-lb to 200 in-lb, alternatively from 50 in-lb to 180 in-lb, alternatively from 100 in-lb to 150 in-lb as determined in accordance with ASTM D-3029; an Izod impact of from 0.4 ft-lbs/in to 5 ft-lbs/in, alternatively from 1 ft-lbs/in to 4 ft-lbs/in, alternatively from 2 ft-lbs/in to 3.5 ft-lbs/in as determined in accordance with ASTM D-256; a tensile strength of from 2,000 psi to 10,000 psi, alternatively from 2,800 psi to 8,000 psi, alternatively from 3,000 psi to 5,000 psi as determined in accordance with ASTM D-638; a tensile modulus of from 100,000 psi to 500,000 psi, alternatively from 200,000 psi to 450,000 psi, alternatively from 250,000 psi to 380,000 psi as determined in accordance with ASTM D-638; an elongation of from 0.5% to 90%, alternatively from 5% to 70%, alternatively from 35% to 60% as determined in accordance with ASTM D-638; a flexural strength of from 3,000 psi to 15,000 psi, alternatively from 4,000 psi to 10,000 psi, alternatively from 6,000 psi to 9,000 psi as determined in accordance with ASTM D-790; a flexural modulus of from 200,000 psi to 500,000 psi, alternatively from 230,000 psi to 400,000 psi, alternatively from 250,000 psi to 350,000 psi as determined in accordance with ASTM D-790; an annealed heat distortion of from 180° F. to 215° F., alternatively from 185° F. to 210° F., alternatively from 190° F. to 205° F. as determined in accordance with ASTM D-648; a Vicat softening of from 195° F. to 225° F., alternatively from 195° F. to 220° F., alternatively from 200° F. to 215° F. as determined in accordance with ASTM D-1525; and a gloss 600 of from 30 to 100, alternatively from 40 to 98, alternatively from 50 to 95 as determined in accordance with ASTM D-523.

Examples of HIPS suitable for use in this disclosure include without limitation 825E, 680, 830, 935E, 975E, 945E, and 845E, all of which are high impact polystyrenes commercially available from Total Petrochemical USA, Inc. and K-RESIN KRO3, which is a styrene butadiene block copolymer commercially available from Chevron Phillips Chemical Company, LLC. In an embodiment, the HIPS (e.g., 825E, 680, 830, 935E, 975E, 945E, 845E, and K-RESIN KRO3) have generally the physical properties set forth in Tables 5-12.

TABLE 5

| | | |
|---|---|---|
| 825E | ASTM Test | Typical Value |

MELT FLOW

| | | |
|---|---|---|
| Flow, g/10 min., 200/5.0 | D-1238 | 3.0 |

IMPACT PROPERTIES

| | | |
|---|---|---|
| Falling Dart, in-lb | D-3029 | 110 |
| Izod, ft-lbs/in, notched | D-256 | 2.3 |

TENSILE PROPERTIES

| | | |
|---|---|---|
| Strength, psi | D-638 | 3,600 |
| Modulus, psi (10⁵) | D-638 | 3 |
| Elongation, % | D-638 | 50 |

FLEXURAL PROPERTIES

| | | |
|---|---|---|
| Strength, psi | D-790 | 6,900 |
| Modulus, psi (10⁵) | D-790 | 3.2 |

THERMAL PROPERTIES

| | | |
|---|---|---|
| Heat Distortion, ° F. Annealed | D-648 | 202 |
| Vicat Softening, ° F. | D-1525 | 215 |

OTHER PROPERTIES

| | | |
|---|---|---|
| Gloss, 60° | D-523 | 70 |

TABLE 6

| | | |
|---|---|---|
| 680 | ASTM Test | Typical Value |

MELT FLOW

| | | |
|---|---|---|
| Flow, g/10 min., 200/5.0 | D-1238 | 2.0 |

IMPACT PROPERTIES

| | | |
|---|---|---|
| Falling Dart, in-lb | D-3029 | 6 |
| Izod, ft-lbs/in, notched | D-256 | 0.9 |

TENSILE PROPERTIES

| | | |
|---|---|---|
| Strength, psi | D-638 | 7,500 |
| Modulus, psi (10⁵) | D-638 | 3.7 |
| Elongation, % | D-638 | 5 |

FLEXURAL PROPERTIES

| | | |
|---|---|---|
| Strength, psi | D-790 | 13,200 |
| Modulus, psi (10⁵) | D-790 | 4.3 |

THERMAL PROPERTIES

| | | |
|---|---|---|
| Heat Distortion, ° F. Annealed | D-648 | 209 |
| Vicat Softening, ° F. | D-1525 | 223 |

OTHER PROPERTIES

| | | |
|---|---|---|
| Gloss, 60° | D-523 | 95 |

TABLE 7

| | | |
|---|---|---|
| 830 | ASTM Test | Typical Value |

MELT FLOW

| | | |
|---|---|---|
| Flow, g/10 min., 200/5.0 | D-1238 | 13.0 |

IMPACT PROPERTIES

| | | |
|---|---|---|
| Falling Dart, in-lb | D-3029 | 120 |
| Izod, ft-lbs/in, notched | D-256 | 2.1 |

TENSILE PROPERTIES

| | | |
|---|---|---|
| Strength, psi | D-638 | 3,300 |
| Modulus, psi (10⁵) | D-638 | 3.2 |
| Elongation, % | D-638 | 45 |

FLEXURAL PROPERTIES

| | | |
|---|---|---|
| Strength, psi | D-790 | 5,700 |
| Modulus, psi (10⁵) | D-790 | 3 |

THERMAL PROPERTIES

| | | |
|---|---|---|
| Heat Distortion, ° F. Annealed | D-648 | 189 |
| Vicat Softening, ° F. | D-1525 | 200 |

OTHER PROPERTIES

| | | |
|---|---|---|
| Gloss, 60° | D-523 | 94 |

TABLE 8

| | | |
|---|---|---|
| 935E | ASTM Test | Typical Value |

MELT FLOW

| | | |
|---|---|---|
| Flow, g/10 min., 200/5.0 | D-1238 | 3.7 |

IMPACT PROPERTIES

| | | |
|---|---|---|
| Falling Dart, in-lb | D-3029 | 140 |
| Izod, ft-lbs/in, notched | D-256 | 2.5 |

TENSILE PROPERTIES

| | | |
|---|---|---|
| Strength, psi | D-638 | 2,800 |
| Modulus, psi (10⁵) | D-638 | 2.5 |
| Elongation, % | D-638 | 60 |

FLEXURAL PROPERTIES

| | | |
|---|---|---|
| Strength, psi | D-790 | 5,500 |
| Modulus, psi (10⁵) | D-790 | 2.6 |

THERMAL PROPERTIES

| | | |
|---|---|---|
| Heat Distortion, ° F. Annealed | D-648 | 196 |
| Vicat Softening, ° F. | D-1525 | 208 |

OTHER PROPERTIES

| | | |
|---|---|---|
| Gloss, 60° | D-523 | 80 |

TABLE 9

| | | |
|---|---|---|
| 975E | ASTM Test | Typical Value |

MELT FLOW

| | | |
|---|---|---|
| Flow, g/10 min., 200/5.0 | D-1238 | 2.8 |

IMPACT PROPERTIES

| | | |
|---|---|---|
| Falling Dart, in-lb | D-3029 | 105 |
| Izod, ft-lbs/in, notched | D-256 | 2.2 |

TENSILE PROPERTIES

| | | |
|---|---|---|
| Strength, psi | D-638 | 2,900 |
| Modulus, psi (10⁵) | D-638 | 2.3 |
| Elongation, % | D-638 | 55 |

FLEXURAL PROPERTIES

| | | |
|---|---|---|
| Strength, psi | D-790 | 5,800 |
| Modulus, psi (10⁵) | D-790 | 2.7 |

THERMAL PROPERTIES

| | | |
|---|---|---|
| Heat Distortion, ° F. Annealed | D-648 | 197 |
| Vicat Softening, ° F. | D-1525 | 210 |

OTHER PROPERTIES

| | | |
|---|---|---|
| Gloss, 60° | D-523 | 60 |

TABLE 10

| | | |
|---|---|---|
| 945E | ASTM Test | Typical Value |

MELT FLOW

| | | |
|---|---|---|
| Flow, g/10 min., 200/5.0 | D-1238 | 3.5 |

IMPACT PROPERTIES

| | | |
|---|---|---|
| Falling Dart, in-lb | D-3029 | 160 |
| Izod, ft-lbs/in, notched | D-256 | 3.2 |

TENSILE PROPERTIES

| | | |
|---|---|---|
| Strength, psi | D-638 | 3,500 |
| Modulus, psi (10⁵) | D-638 | 3 |
| Elongation, % | D-638 | 55 |

FLEXURAL PROPERTIES

| | | |
|---|---|---|
| Strength, psi | D-790 | 6,300 |
| Modulus, psi (10⁵) | D-790 | 3.1 |

THERMAL PROPERTIES

| | | |
|---|---|---|
| Heat Distortion, ° F. Annealed | D-648 | 196 |
| Vicat Softening, ° F. | D-1525 | 208 |

OTHER PROPERTIES

| | | |
|---|---|---|
| Gloss, 60° | D-523 | 90 |

TABLE 11

| | | |
|---|---|---|
| 845E | ASTM Test | Typical Value |

MELT FLOW

| | | |
|---|---|---|
| Flow, g/10 min., 200/5.0 | D-1238 | 3.0 |

IMPACT PROPERTIES

| | | |
|---|---|---|
| Falling Dart, in-lb | D-3029 | 110 |
| Izod, ft-lbs/in, notched | D-256 | 2.4 |

TENSILE PROPERTIES

| | | |
|---|---|---|
| Strength, psi | D-638 | 3,200 |
| Modulus, psi (10⁵) | D-638 | 2.8 |
| Elongation, % | D-638 | 55 |

FLEXURAL PROPERTIES

| | | |
|---|---|---|
| Strength, psi | D-790 | 6,200 |
| Modulus, psi (10⁵) | D-790 | 2.8 |

THERMAL PROPERTIES

| | | |
|---|---|---|
| Heat Distortion, ° F. Annealed | D-648 | 199 |
| Vicat Softening, ° F. | D-1525 | 212 |

OTHER PROPERTIES

| | | |
|---|---|---|
| Gloss, 60° | D-523 | 63 |

TABLE 12

| | | |
|---|---|---|
| K-RESIN KR03 | ASTM Test | Typical Value |

PHYSICAL PROPERTIES

| | | |
|---|---|---|
| Density, g/cc | D-792 | 1.01 |
| Water Absorption, % | D-570 | 0.0900 |
| Melt Flow, g/10 min. | D-1238 | 7.5 |

MECHANICAL PROPERTIES

| | | |
|---|---|---|
| Hardness, Shore D | D-2240 | 65.0 |
| Tensile Strength, Yield, psi | D-638 | 3770 |
| Elongation at Break, % | D-638 | 160 |
| Flexural Modulus, ksi | D-790 | 204.9 |
| Flexural Yield Strength, psi | D-790 | 4930 |
| Impact Test, ft-lb | D-3763 | 21.9 |
| Izod Impact, Notches, ft-lb/in | D-256 | 0.768 |

THERMAL PROPERTIES

| | | |
|---|---|---|
| Deflection Temperature at 1.8 MPa | D-648 | 163 |
| (264 psi), ° F. | | |
| Vicat Softening Point, ° | D-1525 | 189 |

OPTICAL PROPERTIESD-1003

| | | |
|---|---|---|
| Transmission, visible, % | D-1003 | 90.0 |

In an embodiment, the SPC comprises a blend of a GPPS and a HIPS, each of which may be of the type previously described herein. The blend may comprise GPPS:HIPS in a ratio of from 99.9:0.1 to 0.1:99.9, alternatively from 90:10 to 10:90, alternatively from 80:20 to 20:80, alternatively from 70:30 to 30:70, alternatively from 60:40 to 40:60, alternatively 50:50.

In an embodiment, the SPC may further comprise one or more additives as deemed necessary to impart desired physical properties, such as, increased gloss or color. Examples of additives include without limitation chain transfer agents, talc, antioxidants, UV stabilizers, plasticizers, lubricants, mineral oil, and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. These additives may be included in amounts effective to impart the desired properties.

In an embodiment, the SPC further comprises a plasticizer, alternatively mineral oil. Mineral oil may function to soften the SPC and increases its processability. Mineral oil may be present in the SPC in amounts ranging from 0 wt. % to 6.5 wt. %, alternatively from 1.25 wt. % to 4 wt. %, alternatively from 2 wt. % to 3 wt. % based on the total weight of the SPC.

Effective additive amounts and processes for inclusion of these additives to polymeric compositions are known to one skilled in the art with the aid of this disclosure. In an embodiment, one or more additives (e.g., mineral oil, etc.) may be present in the SPC in an amount of from 0 wt. % to 6.5 wt. %, alternatively from 1.25 wt. % to 4 wt. %, alternatively from 2 wt. % to 3 wt. % based on the total weight of the polymeric composition.

Any process known to one of ordinary skill in the art for the production of an SPC (e.g., a GPPS or a HIPS) may be employed. In an embodiment, a method for production of an SPC (i.e., a GPPS) comprises contacting styrene monomer under reaction conditions suitable for the polymerization of the monomer.

In an alternative embodiment, a method for production of an SPC (i.e., HIPS) comprises contacting styrene monomer and other components (e.g., elastomers, initiators, additives, etc.) under reaction conditions suitable for polymerization of the monomer. In such embodiments, the method comprises dissolution of polybutadiene elastomer in styrene that is subsequently polymerized.

In an embodiment, the SPC (e.g., GPPS, HIPS) production process employs at least one polymerization initiator. Such initiators may function as a source of free radicals to enable the polymerization of styrene. In an embodiment, any initiator capable of free radical formation that facilitates the polymerization of styrene may be employed. Such initiators include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides or combinations thereof. In an embodiment, the initiator level in the reaction is given in terms of the active oxygen in parts per million (ppm). In an embodiment, the level of active oxygen level in the disclosed reactions for the production of the SPC is from 20 ppm to 80 ppm, alternatively from 20 ppm to 60 ppm, and further alternatively from 30 ppm to 60 ppm. The selection of initiator and effective amount will depend on numerous factors (e.g., temperature, reaction time) and can be chosen by one skilled in the art with the aid of this disclosure to meet the desired needs of the process. Polymerization initiators and their effective amounts have been described, for example, in U.S. Pat. Nos. 6,822,046; 4,861,127; 5,559,162; 4,433,099; and 7,179,873 each of which is incorporated by reference herein in its entirety.

The polymerization reaction to form the SPC (e.g., GPPS, HIPS) may be carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an embodiment, the polymerization reaction may be carried out using a continuous production process in a polymerization apparatus comprising a single reactor or a plurality of reactors. For example, the polymeric composition can be prepared using an upflow reactor. Reactors and conditions for the production of a polymeric composition are disclosed, for example, in U.S. Pat. No. 4,777,210, which is incorporated by reference herein in its entirety.

The temperature ranges useful with the process of the present disclosure can be selected to be consistent with the operational characteristics of the equipment used to perform the polymerization. In one embodiment, the temperature range for the polymerization can be from 90° C. to 240° C. In another embodiment, the temperature range for the polymerization can be from 100° C. to 180° C. In yet another embodiment, the polymerization reaction may be carried out in a plurality of reactors with each reactor having an optimum temperature range. For example, the polymerization reaction may be carried out in a reactor system employing a first and second polymerization reactors that are either continuously stirred tank reactors (CSTR) or plug-flow reactors. In an embodiment, a polymerization reactor for the production of an SPC of the type disclosed herein comprising a plurality of reactors may have the first reactor (e.g., a CSTR), also known as the prepolymerization reactor, operated in the temperature range of from 90° C. to 135° C. while the second reactor (e.g., CSTR or plug flow) may be operated in the range of from 100° C. to 165° C.

The polymerized product effluent from the first reactor may be referred to herein as the prepolymer. When the prepolymer reaches the desired conversion, it may be passed through a heating device into a second reactor for further polymerization. Upon completion of the polymerization reaction, an SPC is recovered and subsequently processed, for example devolatized, pelletized, etc.

One or more additives (e.g., mineral oil, etc.) of the type described previously herein may also be added after recovery of the SPC (e.g., GPPS, HIPS), for example during compounding such as pelletization. Alternatively or additionally to the inclusion of such additives in the styrenic polymer component of the SPCs, such additives may be added during formation of the SPCs or to one or more other components of the SPCs.

In an embodiment, the resulting SPC (e.g., GPPS, HIPS) may be converted to an intermediate article, referred to as a preform, which may be subsequently converted to an end-use article. The conversion of the polymeric material to a preform and subsequently an end-use article may occur on one production line. Alternatively, the polymeric composition may be converted to a preform, stored, and/or shipped and then later converted to an end-use article. Alternatively, the polymeric composition may be directly converted to an end-use article. The sequence and timing of the conversion of a polymeric composition to a preform and/or end-use article may be designed by one skilled in the art with the aid of this disclosure to meet the needs of the user. An SPC of the type disclosed herein may be converted into an end-use article through a variety of plastic shaping processes. Plastic shaping processes are known to one skilled in the art and include for example and without limitation ISBM.

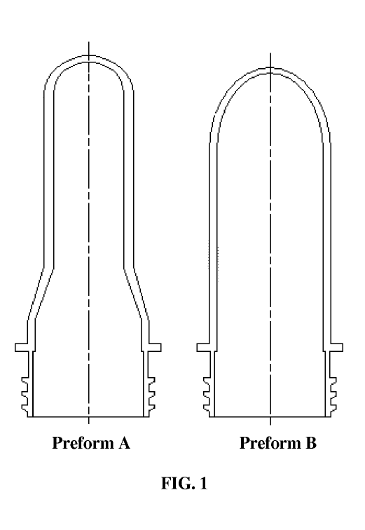

In an embodiment, the SPC is converted to an end-use article by ISBM. In ISBM, the SPC (e.g., pellets, fluffs, etc.) is melted to form a molten polymer. The molten polymer may then be injected into the mold cavity to produce the desired shape of the intermediate or preform article. A preform core is in place during the molding that functions to form the inner diameter of the article. Any suitable mold cavity may be used to produce a preform having a desirable shape. An example of suitable preform includes without limitation preforms referred to as preform A and preform B, embodiments of which are shown in FIG. 1. Additionally, a description of the preform B design can be found in U.S. patent application Ser. No. 11/999,848 filed Dec. 7, 2007, which is incorporated by reference herein in its entirety. The preform is then cooled quickly in the mold cavity and removed from the initial mold. Subsequently, the preform may be reheated which can result in shrinkage or warpage of the preform and which will be described in more detail later herein. The preform may be reheated to a temperature of from 220° F. to 300° F., alternatively from 240° F. to 280° F., alternatively from 250° F. to 275° F.

Heating of the preform may be carried out using parameters (equipment, design or configuration, processing conditions, etc.) suitable for the production of an end-use article having one or more user-desired properties. For example, the heating may be carried out in an oven, using one or more heating elements. The type and number of heating elements, the temperature range used, the configuration of the heating elements in relation to the preform, and other parameters as known to one of ordinary skill in the art and with the benefit of this disclosure may be adjusted to produce a preform having one or more user and/or process desired characteristics. For example, an infrared heater with a high heating rate may be employed to rapidly heat the preform to a desired temperature in order to minimize shrinkage and/or warpage. Alternatively, one or more heating elements may be configured so that the preform can be heated to a desired temperature range. In yet another embodiment, the heating elements may be adjustable and may be configured so as to move with the preform as the preform is conveyed from one processing area to another. For example, the heating element may be configured such that the distance from the heating elements to the preform is constant over some time interval or through one or more manufacturing stages. Other parameters (i.e., of the heating equipment and process conditions) may be configured by one of ordinary skill in the art to produce a preform with desirable processability and properties.

In an embodiment, a preform prepared from an SPC of the type disclosed herein may have a shrinkage percentage of from 0% to 60%, alternatively from 5% to 50%, alternatively from 10% to 40%. The shrinkage percentage herein refers to the percent of preform height change (i.e., decrease) occurred during heating for a preform. The shrinkage percentage may be determined by taking the difference in height of the preform before and after heating, and dividing the difference by the length of preform below the supporting ledge before heating.

In an embodiment, a preform prepared from an SPC of the type disclosed herein may have a warpage percentage during heating of from 0% to 50%, alternatively from 1% to 25%, alternatively from 2% to 10%. The warpage percentage herein refers to the percent of preform center movement during heating. The warpage percentage may be determined by taking the difference in preform center before and after heating, and dividing the difference by the length of preform below the supporting ledge after heating.

The heated preform is then transferred into a blow mold and stretched axially and using air pressure blown to expand the internal volume to its final dimensions. In an embodiment, a preform prepared from an SPC of the type described herein may be expanded to its final dimensions using a blow pressure of less than 10 bar, alternatively less than 8 bar, alternatively less than 7 bar, alternatively less than 5 bar, alternatively less than 4 bar.

Examples of end-use articles into which the SPCs of this disclosure may be formed include food packaging containers, office supplies, plastic lumber, replacement lumber, patio decking, structural supports, laminate flooring compositions, polymeric foam substrate, decorative surfaces (i.e., crown molding, etc.), weatherable outdoor materials, point-of-purchase signs and displays, house wares and consumer goods, building insulation, cosmetics packaging, outdoor replacement materials, lids and containers (i.e., for deli, fruit, candies and cookies), appliances, utensils, electronic parts, automotive parts, enclosures, protective head gear, reusable paintballs, toys (e.g., LEGO bricks), musical instruments, golf club heads, piping, business machines and telephone components, shower heads, door handles, faucet handles, wheel covers, automotive front grilles, and so forth

In an embodiment, the SPC may be converted into ISBM end-use articles. Examples of ISBM end-use articles into which the SPC may be formed include bottles, containers, and so forth. In an embodiment, the ISBM end-use article is a packaging container for a consumer product such as a food storage container or a beverage container. Alternatively, the SPC is used to prepare a packaging container for liquids such as for example a water or milk bottle. The SPC may also be used in bioscience medical articles for example medical bottles, intravenous (IV) bottles, pharmaceutical containers, etc. Additional end-use articles would be apparent to those skilled in the art with the aid of this disclosure.

In an embodiment, an ISBM end-use article prepared from an SPC of the type disclosed herein may display improved mechanical properties (e.g., drop impact strength, top load strength) when compared to an ISBM end-use article from other polymeric compositions (e.g., polypropylene (PP), polyethylene terephthalate (PET)).

Drop impact strength provides information about the strength of an ISBM end-use article when dropped from a height. Tests of the drop impact strength may be carried out by dropping a set number of filled and capped bottles (e.g., 12) vertically onto the bottle base and horizontally onto the bottle side. The weight and the volume of the bottles may include any suitable weight and volume. In an embodiment, the bottle has a weight of 28 g and a volume of 500 mL.

Test of the drop impact strength may comprise dropping bottles, which have been stored at 40° F. or at room temperature for at least 12 hours from 4 or 6 feet (ft). A material is considered to have passed the drop impact strength test if all articles in the set (i.e., 12) were still intact after initial impact and there was zero failure. The failure criteria may include:
a. Any breakage of any location (including cracked base, broken finish), zero is acceptable
b. Delamination of any size and location
c. Denting of any size and location.
   Typically, the experiment may be repeated if the lid on the bottle, instead of the bottle itself, failed.

In an embodiment, a 28 g, 500 mL ISBM end-use article constructed from an SPC of the type disclosed herein may pass a drop impact strength test when dropped vertically or horizontally; from a height of from 0 ft to 8 ft, alternatively from 0 ft to 7 ft, alternatively from 0 ft to 6 ft; at a temperature of from 40° F. to 90° F., alternatively from 50° F. to 80° F., alternatively from 60° F. to 70° F.

Top load strength and bumper compression strength provide information about the crushing properties of an ISBM end-use article when employed under crush test conditions. Tests of the top load and bumper compression strength may be carried out by placing the ISBM article on a lower plate (vertically for top load strength and horizontally for bumper compression) and slowly raising it against an upper plate to measure the corresponding load capacity of the ISBM articles (maximum value for top load strength and the value at ½ inch deflection for bumper compression strength).

In an embodiment, a 28 g, 500 mL ISBM end-use article constructed from an SPC of the type disclosed herein may display a top load strength of from 200 N to 600 N, alternatively from 250 N to 550 N, alternatively from 300 N to 500 N. In an embodiment, a 28 g, 500 mL ISBM end-use article constructed from an SPC of the type disclosed herein may display a bumper compression strength of from 100 N to 400 N, alternatively from 150 N to 350 N, alternatively from 180 N to 320 N.

In an embodiment, a 28 g, 500 mL ISBM end-use article constructed from an SPC of the type disclosed herein may display a gloss 60° of from 20 to 100, alternatively from 25 to 95, alternatively from 30 to 90 as determined in accordance with ASTM D2457. The gloss of a material is based on the interaction of light with the surface of a material, more specifically the ability of the surface to reflect light in a specular direction. Gloss is measured by measuring the degree of gloss as a function of the angle of the incident light, for example at 60° incident angle (also known as “gloss 60°”).

In an embodiment, an ISBM end-use article constructed from an SPC of the type disclosed herein may be opaque. Opaque materials have limited translucence thus shielding any material disposed within or covered by the end-use article from light. The opacity of a material may be indirectly determined by the haze of a material. Haze is the cloudy appearance of a material caused by light scattered from within the material or from its surface. The haze of a material can be determined in accordance with ASTM D1003-00 for a haze percentage of equal to or lower than 30%. A material having a haze percentage of greater than 30% can be determined in accordance with ASTM E167. In an embodiment, a 28 g, 500 mL ISBM end-use article constructed from an SPC of the type disclosed herein may display a haze of from 0.1% to 99.9%, alternatively from 30% to 98%, alternatively from 50% to 95%.

ISBM articles produced from the SPCs of this disclosure may require a lower blowing pressure to produce a preform which may translate to improved manufacturing economics due to a variety of factors such as decreased energy consumption, faster line speed, reduced capital investment, and safer and less noisy environment. The articles (e.g., ISBM articles) of this disclosure may also display mechanical and/or physical properties at values comparable to that of ISBM articles produced using other polymeric materials such as for example PET.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims to follow in any manner.

### Example 1

The effects of various processing conditions during ISBM on articles prepared from styrenic polymers were investigated. First, the effect of mold temperature for making molded preform samples was examined. Two resins were tested, Resin 1 was 500B which was a crystal grade PS and Resin 2 was 845E which was a HIPS both of which are commercially available from Total Petrochemicals USA, Inc. The molded samples were prepared according to the Preform B design previously described herein.

The weights of the preform molded samples were approximately 28 g for both the 500B and 845E resins. Five molded preform samples were prepared using crystal PS 500B resin with mold temperatures of 105° C., 110° C., 120° C., 130° C., and 150° C. Since the five molded preform samples were transparent, their stress distributions were analyzed using polarized light. The source of the polarized light was a Light Polarizer (Model No. C522), which was commercially available from AGR TopWave, LLC.

The results showed that a higher mold temperature led to non-uniform stress distribution, while lower mold temperatures resulted in the formation of wavy patterns that was visually observed under polarized light. The molded preform sample prepared at a mold temperature of 130° C. showed more symmetrical stress distribution. Hereinafter, the mold temperature for making molded preform samples were set to 130° C.

Since a molded preform sample prepared from the 845E resin was opaque, the sample could not be analyzed using a polarized light to optimize its mold temperature. Thus, the mold temperature for HIPS 845E resin was also set to 130° C. Other processing parameters including barrel temperature, hot runner temperature, injection speed, cooling time, hold time, and cycle time were optimized for each resin and are tabulated in Table 13.

TABLE 13

| | Resin 1 | Resin 2 |
|---|---|---|
| Resin | 500B | 845E |
| Preform weight (g) | 28 | 28 |
| Barrel temperature (° C.) | 227 | 250 |
| Hot runner temperature (° C.) | 227 | 250 |
| Mold temperature (static/move) (° F.) | 130 | 130 |
| Injection speed (mm/s) | 5 | 5 |
| Cooling time (s) | 15 | 20 |
| Hold time (s) | 3 | 4 |
| Cycle time (s) | 26.94 | 32.62 |

Three molded preform samples were prepared using the conditions described previously. Sample 1 was prepared from 500B, Sample 2 was prepared from 500B blended with 2% K-RESIN KRO3 and Sample 3 was prepared from 845E. The preform molded samples were heated and then stretch-blow-molded into bottles using ADS G62, which is a linear injection stretch blow molder with two cavities commercially available from ADS, S.A. The shrinkage percentage and warpage percentage were determined and the results are tabulated in Table 14.

TABLE 14

| Sample | Shrinkage | Warpage |
|---|---|---|
| 1 | 40-60% | 10-20% |
| 2 | 40-60% | 10-20% |
| 3 | 20-30% | <5% |

During heating, both Samples 1 and 2 showed non-uniform shrinkage and warpage that may further translate to non-uniform bottle thickness and off-center bottle bottom, while the shrinkage of Sample 3 appeared more uniform in nature. Further, Sample 3 displayed the lowest shrinkage of the three samples. All of the resins investigated (i.e., crystal PS and HIPS) produced preforms that required lower heating energy and were blown to their final dimensions using a lower blow pressure when compared to similar parameters for preforms prepared from other polymeric materials (i.e., PP, PET). Lower heating energy was determined by the sum of the output of the heaters. Typically, the blow pressure required to produce a PP molded preform is in the range of 26-30 bar. However, the blow pressure used for blowing the Samples 1 and 2 was 9 bar, suggesting the blow pressure is reduced by at least a factor of 3 when using the SPCs of this disclosure.

### Example 2

The drop impact strength of ISBM articles made from SPCs of the type described herein was investigated. Seven HIPS resins, designated Samples 4-10, were evaluated. The HIPS resins were 680, 825E, 830, 845E, 935E, 945E, and 975E, all of which are commercially available from Total Petrochemicals USA, Inc. For each of the seven resins, two sets of bottles (each set containing 24 bottles) were made.

Molded preform samples (Preform A design) were prepared and then stretch blow molded into bottles. Each sample was blow molded using two sets of ovens, designated oven 10 and oven 20, at processing speeds of 2000 bottles/hour (b/h) and 3000 b/h, with the exception of Sample 4. At the same speed for processing SPCs to typical speeds for producing PP bottles (which are 2500-3000 b/h) and PET bottles (which are 2800-3200 b/h), all samples prepared using the SPCs of the type described herein required lower preheating energy. For certain preforms, they may be processed using one set of oven only, as shown in Table 15. In addition, Sample 4 produced using 680 HIPS resin possessed lower processability and behaved similarly to a GPPS. The 680 resin exhibited high shrinkage and warpage during reheating, as well as whitening on the molded bottle bottom. The low processability of Sample 4 may be due to the low elastomer concentration in the 680 resin, 2.5 wt. %, when compared to samples prepared using the other HIPS resins which had elastomer concentrations ranging from 6 wt. % to 10 wt. %.

The bottles were then aged for a minimum of 24 hours at ambient temperature, and filled with water, capped, and stored for a minimum of 12 hours at 40±2° F. or 68±2° F. and tested immediately. From the first set, 12 bottles were dropped vertically onto the bottle base from 6 feet (ft) at 40° F., and another 12 bottles were dropped horizontally onto the bottle side from 6 ft at 40° F. From the second set, 12 bottles were dropped vertically onto the bottle base from 4 ft at room temperature, and another 12 bottles were dropped horizontally onto the bottle side from 4 ft at room temperature. The experiment was repeated if the lid on the bottle, instead of the bottle itself, failed. The details of the samples, processing conditions, and results are tabulated in Table 15.

TABLE 15

| | | | | | Drop Impact Strength | |
|---|---|---|---|---|---|---|
| | | | Processing | | 6 feet, | 4 feet, room |
| Sample | Resin | MFR | Two Ovens | One Oven | 40° F. | temperature |
| 4 | 680 | 2.0 | 2000 and 3000 b/h | Only at 2000 b/h | Fail | Fail |
| 5 | 825E | 3.0 | 2000 and 3000 b/h | 2000 and 3000 b/h | Pass | n/a |
| 6 | 830 | 13 | 2000 and 3000 b/h | 2000 and 3000 b/h | Pass | n/a |
| 7 | 845E | 3.0 | 2000 and 3000 b/h | 2000 and 3000 b/h | Pass | n/a |
| 8 | 935E | 3.7 | 2000 and 3000 b/h | 2000 and 3000 b/h | Pass | n/a |
| 9 | 945E | 3.5 | 2000 and 3000 b/h | 2000 and 3000 b/h | Pass | n/a |
| 10 | 975E | 2.8 | 2000 and 3000 b/h | 2000 and 3000 b/h | Pass | n/a |

The results demonstrate that with the exception of Sample 4 all of the bottles passed the drop impact strength test at 6 ft and 40° F. As discussed previously, Sample 4 was prepared from the 680 resin which had the lowest elastomer content of all the resins utilized. The drop impact strengths of samples prepared using the SPCs of this disclosure are comparable to the results of PP impact copolymer (ICP) bottles, which also pass 40° F. drop impact test from a height of 6 feet. Drop impact strength tests at 4 feet for Samples 5-10 were not carried out since those samples passed the tests at 6 feet.

### Example 3

The top load strength of bottles prepared using SPCs of the type described herein was investigated and compared to the top load strength of a bottle prepared using a PP and PET composition. Seven samples were prepared using styrenic polymer resins, designated Samples 11-17; three samples were prepared using PP resins, designated Samples 18-20, and one sample was prepared using PET resin, designated Sample 21. The resin type, number of ovens used, and processing speed for each preform sample are tabulated in Table 16. The styrenic polymer resins were the previously described 680, 830, 945E, and 845E resins. The PP resins were 7525MZ, which is a random PP copolymer, 4280W which is an impact PP copolymer, and 3270 which is a high crystalline PP, all of which are commercially available from Total Petrochemical USA, Inc. The PET resin was a bottle-grade PET commercially available from Resilux. The preform weights for Samples 11-17 were 28 g, the preform weights for Samples 18-20 were 23 g, and the preform weight for Sample 21 was 25 g. The top load strength of each was determined as described previously.

TABLE 16

| Sample | Resin | Oven | Processing Speed (b/h) |
|---|---|---|---|
| 11 | 680 | Two ovens | 2000 |
| 12 | 830 | Two ovens | 2000 |
| 13 | 945E | Two ovens | 2000 |
| 14 | 845E | Two ovens | 2000 |
| 15 | 845E | Two ovens | 3000 |
| 16 | 845E | One oven | 2000 |
| 17 | 845E | One oven | 3000 |
| 18 | 7525MZ | Two ovens | 2000 |
| 19 | 4280W | Two ovens | 2000 |
| 20 | 3270 | Two ovens | 2000 |
| 21 | bottle-grade PET | Two ovens | 2000 |

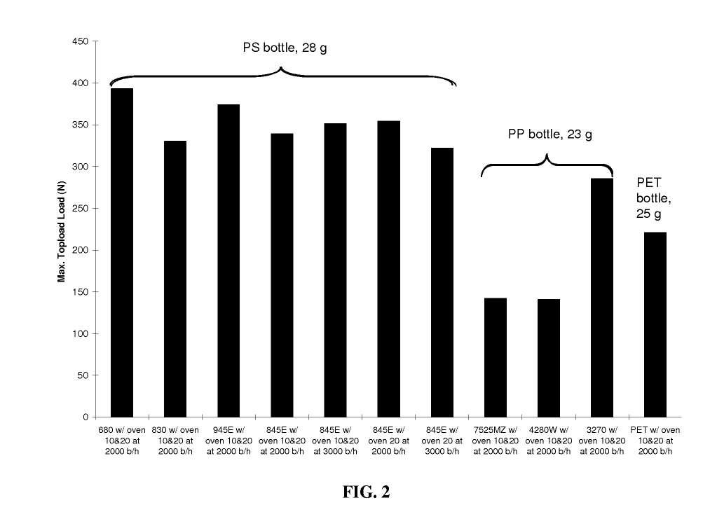

FIG. 2 is a plot of maximum top load for Samples 11-21. The samples prepared using SPCs of the type described herein, Samples 11-17, showed approximately twice the maximum top loads of the samples prepared using random and impact PP copolymers, Samples 18-19. Samples 11-17 also showed higher maximum top loads when compared to Sample 20 prepared using crystalline PP and Sample 21 prepared using PET.

### Example 4

The bumper compression strength and gloss of SPC bottles was investigated and compared to the bumper compression strength and gloss of PP and PET bottles. Samples 11-21 were used to prepare SPC, PP, and PET bottles as described in Example 3. All Samples 11-21 were tested for their bumper compression strengths.

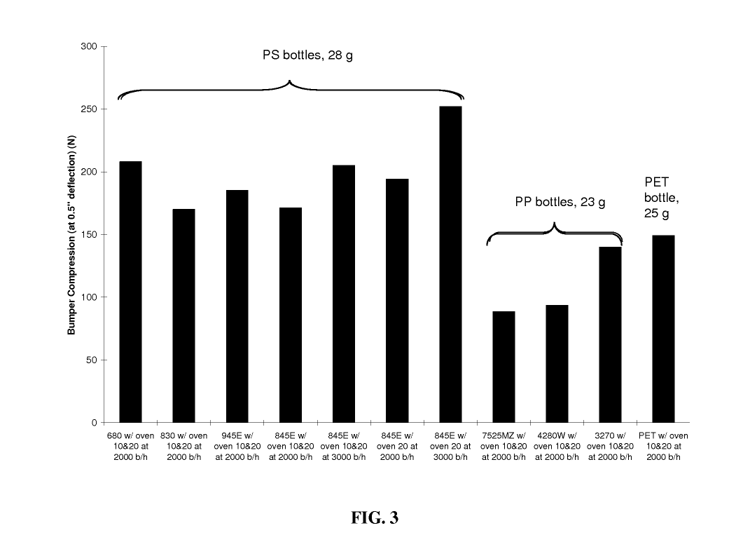

FIG. 3 is a plot of bumper compression strengths at ½ inch deflection for Samples 11-21. The samples prepared using SPCs (Samples 11-17) displayed a higher bumper compression strength when compared to PP (Samples 18-20) and PET (Sample 21).

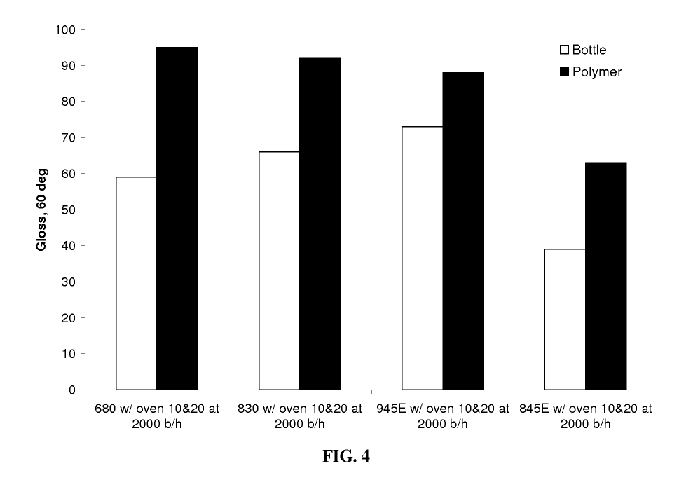

The gloss 60° of SPC bottles was determined. In addition, polymer chips of with a thickness of 90 mils were prepared from SPC samples. FIG. 4 is a plot of gloss 60° for the polymer chips and the bottles for Samples 11-14 prepared from the SPCs. Overall, the bottles showed lower gloss when compared to the polymer chips. The lower gloss of the bottles may be due to their rougher surface since injection molded parts usually have a smoother surface than blow molded parts. Also, the blow molded containers have a much lower wall thickness compared to the molded step chips, which also leads to lower surface gloss.

### Example 5

The haze of SPC bottles was investigated. Six samples, designated Samples 22-27, were prepared from 525, which is a commercially available GPPS from Total Petrochemical USA, Inc. and K-RESIN KRO3, which is a commercially available K-RESIN from Chevron Phillips. The total weight percentages of 525 and K-RESIN KRO3 for Samples 22-27 are tabulated in Table 17.

TABLE 17

| | | | | | Bumper | | | | |
|---|---|---|---|---|---|---|---|---|---|
| | | | | | Compression Strength | | Top Load Strength | | |
| | | K-RESIN | | | Load at ½” | Load at ½” | Max | | |
| | 525, | KR03, | Gauge, | Haze, | deflection | deflection | load | Max load | Failure |
| Sample | wt. % | wt % | inch | % | (N) | stdev (N) | (N) | stdev (N) | location |
| 22 | 10 | 90 | 0.0189 | 2.6 | 78 | 9 | 151 | 7 | bottom |
| 23 | 25 | 75 | 0.019 | 1.2 | 106 | 5 | 195 | 7 | bottom |
| 24 | 50 | 50 | 0.01845 | 1.3 | 128 | 9 | 268 | 16 | bottom |
| 25 | 75 | 25 | 0.01865 | 1.2 | 161 | 9 | 324 | 8 | bottom |
| 26 | 90 | 10 | 0.0198 | 1.1 | 187 | 19 | 398 | 17 | neck |
| 27 | 0 | 100 | 0.01815 | 1.2 | 75 | 11 | 131 | 3 | Bottom |

Samples 22-27 showed a range of haze of from 1.1% to 2.6%, a range of bumper compression strength of from 75 N to 187 N, and a range of top load strength of from 131 N to 398 N.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

1. A method comprising:
preparing a styrenic polymer composition;
melting the styrenic polymer composition to form a molten polymer;
injecting the molten polymer into a mold cavity to form a preform;
heating the preform to produce a heated preform; and
expanding the heated preform to form an article,
wherein the styrenic polymer composition comprises a blend of a general purpose styrene and a high impact polystyrene in a ratio of from 60:40 to 0.1:99.9.

2. (canceled)

3. (canceled)

4. The method of claim 1 wherein the styrenic polymer composition has a melt flow rate of from 1 g/10 min. to 40 g/10 min.

5. The method of claim 1 wherein the styrenic polymer composition has a tensile strength of from 2,000 psi to 10,000 psi.

6. The method of claim 1 wherein the styrenic polymer composition further comprises a plasticizer.

7. The method of claim 6, wherein the plasticizer comprises a mineral oil which is present in an amount of from 0% to 6.5% based on the total weight of the styrenic polymer composition.

8. The method of claim 2 wherein the high impact polystyrene comprises an elastomer.

9. The method of claim 8 wherein the elastomer comprises a conjugated diene monomer, 1,3-butadiene, 2-methyl-1,3-butadiene, 2-chloro-1,3 butadiene, 2-methyl-1,3-butadiene, and 2-chloro-1,3-butadiene, an aliphatic conjugated diene monomer, C₄ to C₉ diene, butadiene monomer, polybutadiene, blends thereof, copolymers thereof, or combinations thereof.

10. The method of claim 8 wherein the elastomer is present in the high impact polystyrene in an amount of equal to or greater than 1 wt.% based on the total weight of the high impact polystyrene.

11. The method of claim 1 wherein the heated preform has a shrinkage of from 0.5% to 60%.

12. The method of claim 1 wherein the heated preform has a warpage of from 0.5% to 50%

13. The method of claim 1 wherein the article comprises a bottle, a container, a packaging container, a food storage container, a beverage container, a bioscience medical article, or combinations thereof.

14. The method of claim 1 wherein the preform, when formed into a test bottle having a weight of 28 g and a volume of 500 mL, passes a drop impact strength test when dropped vertically or horizontally from a height of from 0 ft to 8 ft at a temperature of from 40 ° F. to 90 ° F.

15. The method of claim 1 wherein the preform, when formed into a test bottle having a weight of 28 g and a volume of 500 mL, has a top load strength of from 200 N to 600 N.

16. The method of claim 1 wherein the preform, when formed into a test bottle having a weight of 28 g and a volume of 500 mL, has a bumper compression strength of from 100 N to 400 N.

17. The method of claim 1 wherein the preform, when formed into a test bottle having a weight of 28 g and a volume of 500 mL, has a gloss 60° of from 20 to 100.

18. The method of claim 1 wherein the preform, when formed into a test bottle having a weight of 28 g and a volume of 500 mL, has a haze of from 0.1% to 99.9%.

19. The method of claim 1 wherein the preform, when formed into a test bottle having a weight of 28 g and a volume of 500 mL, requires a blow pressure for expansion of the preform equal to or less than 10 bar.

20. A method comprising substituting a styrenic polymer composition comprising from 0 wt.% to 6.5 wt. % plasticizer and equal to or greater than 2.5 wt. % elastomer for polyethylene terephthalate in an injection stretch blow molding process, wherein the wt.% is based on the total weight of the polymeric composition, and wherein the styrenic polymer composition comprises a blend of a general purpose polystyrene and a high impact polystyrene in a ratio of from 99.9:0.1 to 0.1:99.9.

21. A method comprising:
preparing a preform form a styrenic polymer composition;
subjecting the preform to one or more heating elements; rapidly heating the preform to produce a heated preform; and
wherein the preform has a warpage of from 0.5% to 50%.

22. The method of claim 21 wherein the preform displays a shrinkage of from 0.5% to 60%.

23. The method of claim 21 wherein the heating elements are uniformly distributed around the preform.
